(19) United States
(12) Patent Application Publication
(10) Pub. No.: US 2018/0241748 A1
(43) Pub. Date: Aug. 23, 2018

(54) AUTHENTICATION SERVER, AUTHENTICATION METHOD, AND PROGRAM

(71) Applicant: CANON KABUSHIKI KAISHA, Tokyo (JP)

(72) Inventor: Shunsuke Mogaki, Kawasaki-shi (JP)

(21) Appl. No.: 15/754,537

(22) PCT Filed: Aug. 8, 2016
(86) PCT No.: PCT/JP2016/003647

§ 371 Date: Feb. 22, 2018

(30) Foreign Application Priority Data
Sep. 1, 2015 (JP) 2015-171711

(51) Int. Cl. H04L 29/06

(52) U.S. Cl. CPC H04L 63/0876; H04L 63/105

(57) ABSTRACT

If a plurality of services in the same domain is provided as a plurality of subdomains when a cookie is used in web service, the cookie with a domain scope for a subdomain may not be shared by the services. Meanwhile, if the domain scope is equivalent to the overall domain, a cookie may be obtained for service unavailable for a user, which may disadvantageously reduce security. The authentication server receives access to the server from a terminal and confirms whether the terminal has an authorization to use the services provided by the subdomains in the same domain. If the terminal has the authorization, a cookie is issued with a scope of use for the subdomains to the terminal. If the terminal does not have the authorization, a cookie is issued with a scope of use for the subdomain of the authentication server to the terminal.

### TECHNICAL FIELD

The present invention relates to a method of determining the domain range of an issued cookie if a plurality of web services is provided for different subdomains in the same security domain.

### BACKGROUND ART

In web services provided on the Internet, a cookie system is used for storing, in a web browser, information issued by the web services. Servers protected by an authentication function are generally accessed using cookies that are authentication tokens or authentication sessions stored in clients' web browsers so as to indicate successful authentication. In the use of web service, a cookie is transmitted from a client to the server, allowing the server to identify a user and provide service. In view of security, a cookie has the function of setting a domain that enables the cookie and limiting web service capable of acquiring cookie information. If a domain scope is set for a cookie, a web browser transmits the cookie only for web service corresponding to the domain scope, allowing the transmission of the cookie.

In this case, a plurality of services may be provided as subdomains in a single domain. For example, in a domain “example.com”, a service A subdomain “AAA.example.com”, a service B subdomain “BBB.example.com” and the like can be provided. In the cookie system, services can issue and acquire cookies only in scopes included in the domains of the services.

For example, service A can issue and obtain a cookie with a subdomain “AAA.example.com” of the service in scope and a cookie with a domain “example.com” containing the subdomain of the service in scope. However, a cookie with a subdomain “BBB.example.com” of service B in scope cannot be issued or used. Thus, after accessing the service of any one of the subdomains and performing authentication, in order to skip authentication when using service with a different subdomain, the scope of the cookie needs to cover the overall domain (“example.com”). Such a wide cookie scope may however allow acquisition of cookie information in all services in the same domain. This may unfortunately obtain unintended service or information.

The method of Patent Literature 1 is proposed as a solution to this problem. In the related art, a login to authentication service serving as a subdomain issues a cookie set only with a subdomain where authentication service is provided and a cookie for setting an overall domain with a wide domain scope. At this point, only verification information is set for a cookie with a wide domain scope without authentication information. In these services, the verification information is acquired from a cookie with a wide domain scope and an inquiry is made to the authentication service, allowing acquisition of user authentication information.

### CITATION LIST

### Patent Literature

PTL 1: Japanese Patent Application Laid-Open No. 2014-529156

### SUMMARY OF INVENTION

### Technical Problem

Even if the service of multiple subdomains is provided for the same security domain, the related art can prevent acquisition of information from a cookie in unintended subdomain service. In the related art, unfortunately, issuing of unnecessary cookies cannot be prevented. When a cookie is received in service, an inquiry is made to authentication service using information acquired from the cookie, allowing acquisition of user information and the like. Thus, even in service unused by a user, the service user who uses another subdomain can obtain user information on the user.

### Solution to Problem

The present invention has been devised in view of the problem and provides an authentication server including a confirming unit that receives access to the authentication server from a terminal and confirms whether the terminal is authorized to use a plurality of services provided by a plurality of subdomains in the same domain; and an issuing unit that issues a cookie with a scope of use for the subdomains to the terminal if the confirming unit confirms that the terminal is authorized, and issues a cookie with a scope of use for the subdomain of the authentication server to the terminal if the confirming unit confirms that the terminal is not authorized.

### Advantageous Effects of Invention

The present invention can issue cookies in a proper scope according to service available for users, thereby preventing cookie information from being acquired in unnecessary service.

Further features of the present invention will become apparent from the following description of exemplary embodiments with reference to the attached drawings.

### BRIEF DESCRIPTION OF DRAWINGS

FIG. 1 is a system overall view.

FIG. 2 is a hardware configuration diagram of a server.

FIG. 3A is a software configuration diagram of an authentication server.

FIG. 3B is a software configuration diagram of a resource server.

FIG. 3C is a software configuration diagram of a terminal.

FIG. 4 is a flowchart of issuing cookies.

FIG. 5 is a flowchart of using cookies.

FIG. 6A is a service usage flowchart when cookies are not issued.

FIG. 6B is a service usage flowchart when cookies are not issued.

### DESCRIPTION OF EMBODIMENTS

Exemplary embodiments for implementing the present invention will be described below with reference to the accompanying drawings. Steps “S” are illustrated in flowcharts.

### Embodiment 1

In Embodiment 1, it is assumed that a plurality of online services is provided on the Internet as different subdomain services in the same domain. In this case, “online service” used herein is a group of functions provided by a web site, a web application, a web service and the like which are software executed by a server computer.

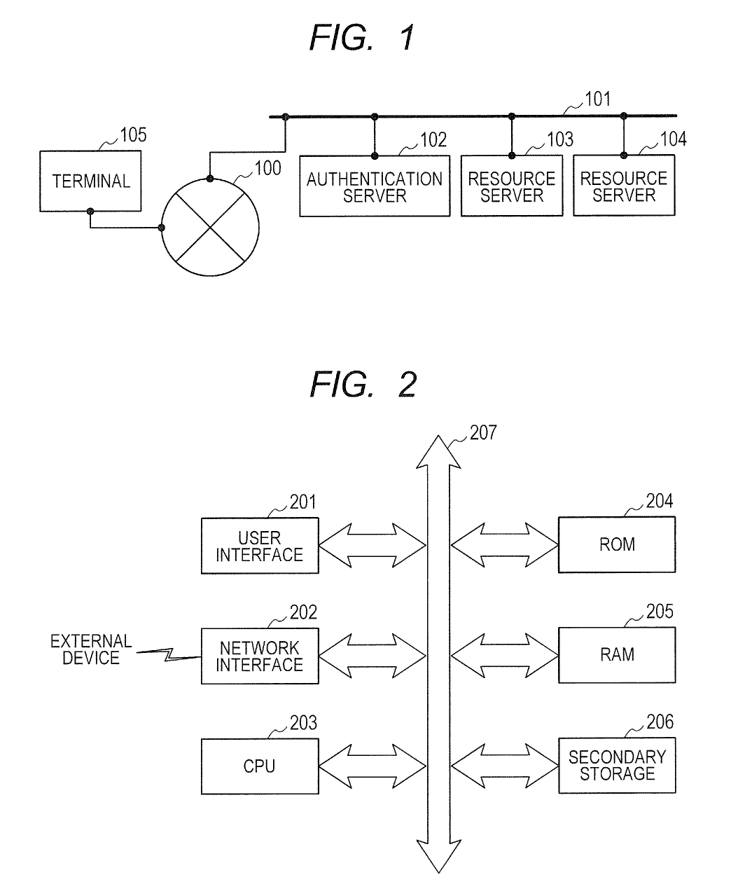

In the present embodiment, “Cookie” is information stored in a web browser 320 of a terminal 105, which will be discussed later, by servers illustrated in FIG. 1. “Cookie” is data including information indicating successful authentication in an authentication server 102. The information indicating successful authentication is, for example, authentication tokens or authentication session information. The cookie is transmitted from the web browser 320 when access is made to web service on the servers of FIG. 1, and the cookie is used for user identification. Thus, once the user is successfully authenticated, the user can advantageously use subsequent service without being authenticated again.

FIG. 1 illustrates a network configuration provided with various web services. An Internet 100 is a public network connectable from the outside. An intranet 101 is a private network, e.g., a LAN not connectable from the outside. An authentication server 102 is a service system that manages user authentication information and authorization information. Resource servers 103 and 104 are web service systems that provide resource service including printing service and document service. The resource servers 103 and 104 provide resource service in response to a request from the client terminal 105 or an external service system (not shown) through the Internet 100. Each of the resource servers is provided with at least one resource service. The authentication server 102 and the resource servers 103 and 104 may be configured on the same server or on respective LANs. Although each of the servers includes one server in Embodiment 1, it may include a plurality of servers. The terminal (client terminal) 105 is a PC, a portable terminal called a smartphone or a tablet, or an image forming apparatus. The web browser 320 is installed on the terminal 105.

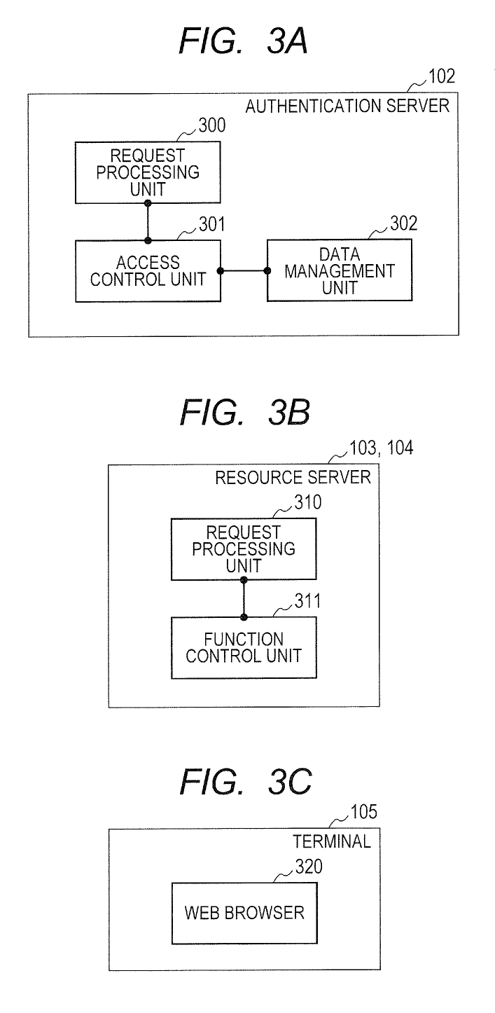

FIG. 2 is a hardware configuration diagram for the servers provided with the services illustrated in FIG. 1. A user interface 201 is hardware that inputs and outputs information with a display, a keyboard, or a mouse. A computer not provided with such hardware can be connected or operated from other computers via remote desktop. A network interface 202 is hardware connected to a network, e.g., a LAN to communicate with other computers and network devices. A CPU 203 runs programs read from a ROM 204, a RAM 205, and a secondary storage 206 and performs various services. The ROM 204 is a storage where installed programs and data are recorded. The RAM 205 is a temporary memory area. The secondary storage 206 is an external storage typified by an HDD. These units are connected via an input/output interface 207.

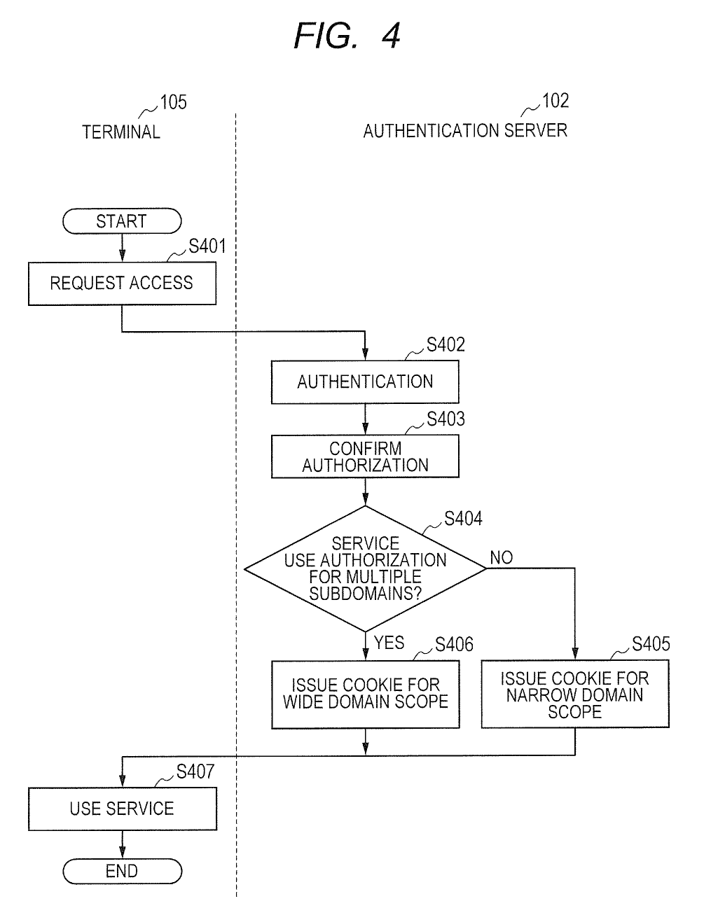

FIGS. 3A to 3C illustrate the module configurations of the authentication server 102, the resource servers 103 and 104, and the terminal 105, respectively, according to the present embodiment. The authentication server 102 provides authentication service using a request processing unit 300, an access control unit 301, and a data management unit 302. The request processing unit 300 processes a request to the authentication server, the request being received by the authentication server 102 via the Internet and the intranet. Moreover, the request processing unit 300 returns response data returned from the access control unit 301, to a caller. The access control unit 301 processes authentication and an authentication request based on data obtained from the data management unit 302. Moreover, the access control unit 301 adds an account or change account information for the data management unit 302. The data management unit 302 manages data on user accounts, the authorization information, and associated service information.

The resource servers 103 and 104 provide resource service using a request processing unit 310 and a function control unit 311. The request processing unit 310 processes a request to resource service received by the resource servers 103 and 104 via the Internet and the intranet. Moreover, the request processing unit 310 returns a processing result returned from the function control unit 311, to the caller. The function control unit 311 performs necessary processing in response to a request received by the request processing unit 310 and then returns response data to the caller.

The terminal 105 includes the web browser 320. The web browser 320 is a user agent for using WWW and makes access to the authentication server 102 and the resource servers 103 and 104 via the internet 100.

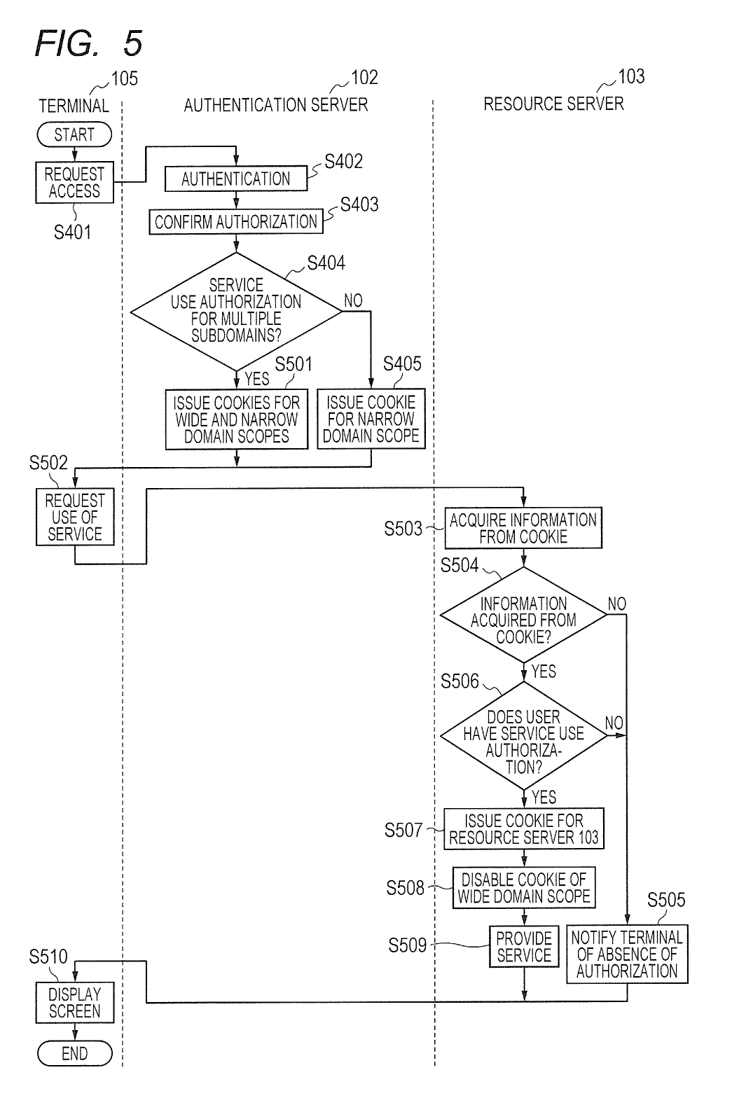

FIG. 4 is a flowchart of issuing cookies in access to the authentication service. The authentication service is provided by the authentication server 102. First, in S401, a user accesses the authentication server 102 with the web browser 320 on the terminal 105. The accessed authentication server 102 performs authentication in S402 and issues an authentication token. An example of account information managed in the data management unit 302 by the authentication server 102 will be discussed below. In the present embodiment, the authentication server 102 performs an authentication with a user ID “admin@1001AA.”

TABLE 1
Account Table

| User ID | Password |
|---|---|
| admin@1001AA | ****** |
| user@1001AA | ****** |
| admin@1002AA | ****** |

In S403, the authentication server 102 confirms the authorization of an authenticated user from the account table and a role table. Whether the authenticated user is authorized to use the service of a plurality of subdomains is confirmed from a service table. An example of role information managed in the data management unit 302 by the authentication server 102 and an example of service information will be discussed below.

In the present embodiment, it is confirmed from the role table that role IDs “role A”, “role B”, and “role C” are set for the user ID “admin@1001AA.” Moreover, it is decided from the service table that the user is authorized to use service A for “role A”, service B for “role B”, and service C for “role C.”

TABLE 2
Role Table

| User ID | Role ID |
|---|---|
| admin@1001AA | Role A |
| admin@1001AA | Role B |
| admin@1001AA | Role C |
| user@1001AA | Role A |
| admin@1002AA | Role A |
| admin@1002AA | Role C |

TABLE 3
Service Table

| Service ID | Role ID | Domain |
|---|---|---|
| Service A | Role A | AAA.example.com |
| Service B | Role B | BBB.example.com |
| Service C | Role C | CCC.example.com |

In S404, the authentication server 102 determines whether the user is authorized to use the service of a plurality of subdomains. If the user is not authorized to use the service of the multiple subdomains, the process advances to S405. If the user is authorized to use the service, the process advances to S406. The subdomains provided with the services can be confirmed on the service table. In the present embodiment, service A is provided by a subdomain “AAA.example.com”, service B is provided by a subdomain “BBB.example.com”, and service C is provided by a subdomain “CCC.example.com.” Thus, it is determined that the user “admin@1001AA” is authorized to use the service of the multiple subdomains. In S403 and S404, whether the user is authorized to use the service of the multiple subdomains is determined according to a role set for the user. The authorization may depend on other user attribute information or the authorization of a user's group.

In S405, since the user is not authorized to use the service of the multiple subdomains, the authentication server 102 issues a cookie specific to the subdomain provided by the accessed authentication server, and stores an authentication token for the cookie. Subsequently, a response is returned to the terminal 105 in response to an access request received in S402.

In S406, since the user is authorized to use the service of the multiple subdomains, the authentication server 102 issues a cookie with a wide domain scope (scope of use) and stores an authentication token for the cookie. Subsequently, a response is returned to the terminal 105 in response to an access request received in S402. In the present embodiment, since the user is authorized to use the service of the multiple subdomains, a cookie with a domain scope of “example.com” is issued and the authentication token for the user “admin@1001AA” is stored for the issued cookie.

In S407, the terminal 105 uses the service using the received cookie. When accessing web service corresponding to the domain scope of the received cookie, the terminal 105 transmits the cookie to the service. When the cookie is received in the service, the authentication token is obtained from the cookie to identify the user, and then the service is provided without a request for authentication.

The method described in Embodiment 1 automatically determines a domain scope set for a cookie, according to the authorization of a user. This issues a cookie only with the scope of an accessed subdomain for a user who is not authorized to use the service of the multiple subdomains, thereby preventing cookie information from being transmitted to unnecessary service. Meanwhile, for a user authorized to use the service of the multiple subdomains, a cookie is transmitted when access is made to the service of a different subdomain, allowing the availability of the service of the different subdomain.

### Embodiment 2

In Embodiment 2, it is assumed that the service of different subdomains is used. Even if the web service of the multiple subdomains is used, a cookie continuously used with a wide domain scope may be provided for unintended service. Embodiment 2 will describe cookie management when a user authorized to use the web service of multiple subdomains makes access to the service of a different subdomain.

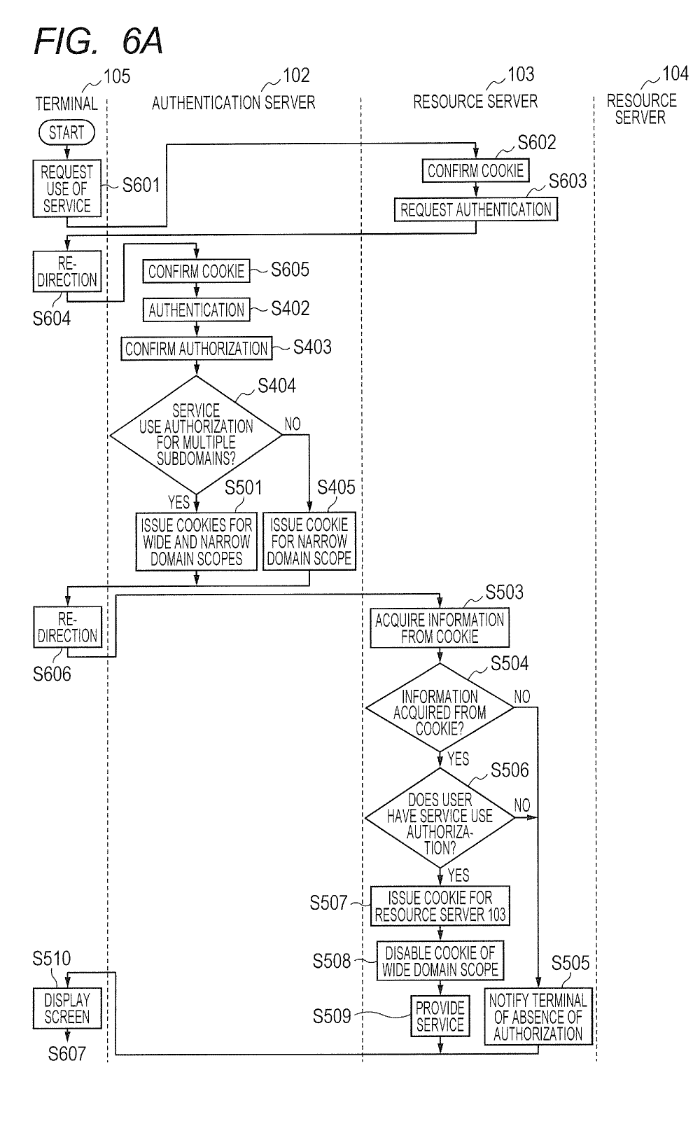

FIG. 5 is a flowchart of using authentication service and resource service with a different subdomain from that of the authentication service. In this case, the authentication service is provided by an authentication server 102 with a subdomain of “AAA.example.com.” The resource service is provided by a resource server 103 (service B) with a subdomain of “BBB.example.com.”

Processing in S401 to S405 is identical to the flowchart described in FIG. 4 and thus the explanation thereof is omitted. In S501, the authentication server 102 issues two cookies: a cookie with a wide domain scope and a cookie with a narrow domain scope specific to the subdomain of the authentication server 102.

Subsequently, a response is returned to a terminal 105 as a response to an access request received in S402. In the present embodiment, authentication is performed with a user ID “admin@1001AA.” In S501, a cookie is issued with a wide domain scope where a domain “example.com” is set and a cookie is issued with a narrow domain scope where a subdomain “AAA.example.com” of authentication service is set.

In S502, in order to use service B, the user makes access to the resource server 103 with a web browser 320 on the terminal 105. In S503, the resource server 103 acquires information from the cookie and then in S504, it is determined whether the information has been acquired from the cookie. If the authentication information has not been acquired from the cookie, the process advances to S505. The authentication information cannot be acquired, for example, if a cookie with the usable domain of the resource server 103 is not stored in the web browser 320 and thus is not transmitted or if the authentication information is not stored in a cookie. In S505, the resource server 103 notifies the terminal 105 that the user is not authorized to use service B.

In S504, if it is determined that the authentication information has been acquired from the cookie, the process advances to S506. In the present embodiment, the cookie with the domain of “example.com” in scope is issued, allowing the resource server 103 to acquire an authentication token from the cookie. If only the cookie with the subdomain of “AAA.example.com” in scope is issued, the resource server 103 cannot obtain the authentication token and thus is unable to provide service.

In S506, it is confirmed whether the user is authorized to use service based on the authentication information acquired from the cookie. The authorization is confirmed by requesting the authentication server 102 to verify authorization or examining user information acquired by the resource server 103. If the user is not authorized to use the service, the process advances to S505, otherwise the process advances to S507. In the present embodiment, the authentication token of the user “admin@1001AA” obtained from the cookie is verified to determine that the user is authorized.

In S507, the resource server 103 issues a cookie with the subdomain of service B in scope and then the information acquired in S503 is stored in the cookie. In the present embodiment, a cookie with a subdomain “BBB.example.com” in scope is issued and the authentication token of user “admin@1001AA” is stored in the cookie.

In S508, the resource server 103 disables a cookie with a wide domain scope. In the present embodiment, the cookie with the domain “example.com” in scope is caused to expire by changing the expiration date of the cookie, disabling the cookie with a wide domain scope. In S509, the resource server 103 provides service B. In S510, the terminal 105 displays received information on the screen of the web browser 320 on the terminal 105.

According to the method of Embodiment 2, when the user authorized to use the multiple subdomains makes access to the service of a different subdomain, the cookie with a wide domain scope is disabled. Thus, even if the user is authorized to use the multiple subdomains, it is possible to prevent cookie information from being transmitted to unintended service.

### Embodiment 3

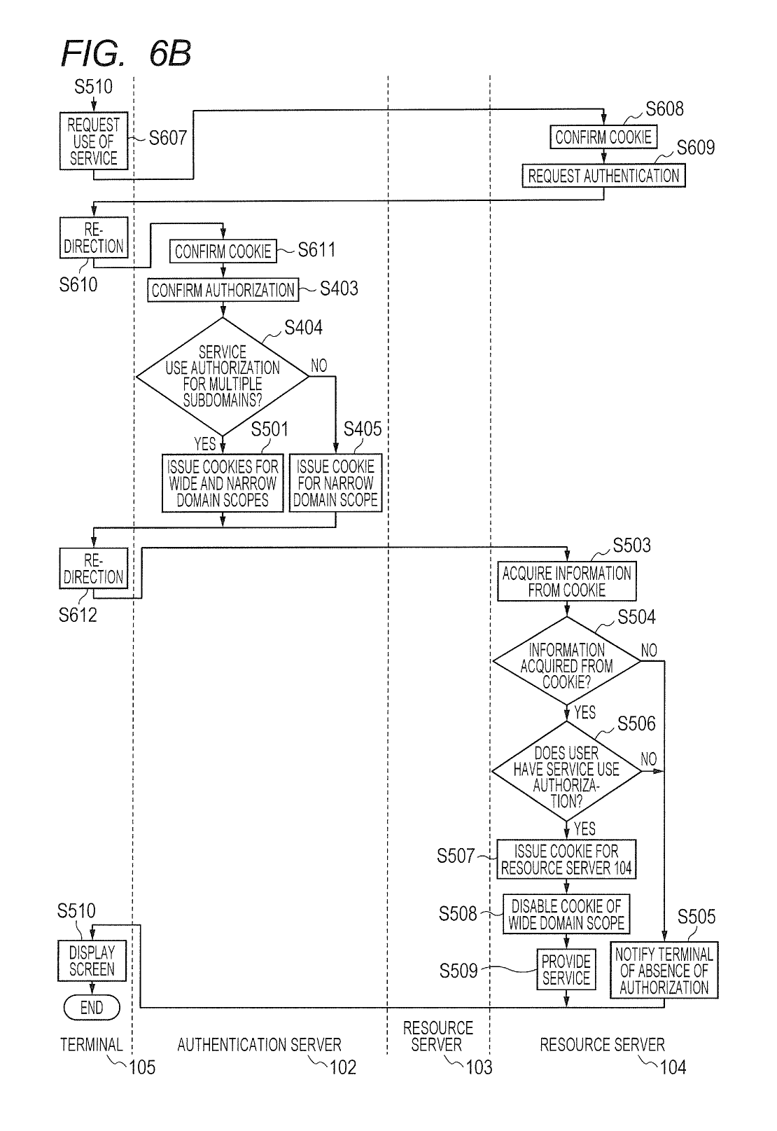

In Embodiment 3, it is assumed that the service of different subdomains is used without issuing a cookie with a wide domain scope. FIGS. 6A and 6B are usage flowcharts of authentication service with different subdomains, service B provided by a resource server 103, and service C provided by a resource server 104.

First, in S601 of FIG. 6A, a terminal 105 requests use of service B to the resource server 103 with a web browser 320. In S602, the resource server 103 acquires information from a cookie. In this case, a cookie with a wide domain scope and a cookie for service B are not issued and thus information cannot be acquired from a cookie. For this reason, in S603, the resource server 103 returns an authentication request to the terminal 105 along with an instruction of redirection to an authentication server 102. In S604, the web browser 320 on the terminal 105 redirects the authentication request to an authentication server 102.

In S605, the authentication server 102 acquires information from a cookie. In this case, a cookie with a wide domain scope and a cookie for authentication service are not issued and thus information cannot be acquired from a cookie. Since an authentication token has not been obtained from a cookie, the authentication server 102 performs user authentication in S402. Processing in S402 to S405 and S501 is identical to the flowchart described in FIG. 5 and thus the explanation thereof is omitted. In the present embodiment, authentication is performed with a user ID “admin@1001AA.” Thus, in S405, a cookie is issued with a wide domain scope where a domain “example.com” is set and a cookie is issued with a narrow domain scope where a subdomain “AAA.example.com” is set. In S606, the terminal 105 redirects a received response to the resource server 103 as a response of S604.

When receiving the response of the authentication request, the resource server 103 acquires information from the cookie to provide service. Processing in S503 to S510 is identical to the flowchart described in FIG. 5 and thus the explanation thereof is omitted. In the present embodiment, the resource server 103 acquires an authentication token from a cookie with a wide domain scope and issues a cookie with a narrow domain scope where a subdomain “BBB.example.com” of the resource server 103 is set. Furthermore, the cookie with a wide domain scope is disabled. After the processing of S510, the flow advances to S607 of FIG. 6B.

In S607 of FIG. 6B, the terminal 105 requests the use of service C to the resource server 104 with the web browser 320 on the terminal 105.

In S608, the resource server 104 acquires information from a cookie. In this case, a cookie with a wide domain scope and a cookie for the domain of service C are not issued and thus information cannot be acquired from a cookie. Thus, in S609, the resource server 104 returns an authentication request to the terminal 105 along with an instruction of redirection to the authentication server 102.

In S610, the web browser 320 on the terminal 105 redirects the authentication request to the authentication server 102.

In S611, the authentication server 102 acquires information from a cookie. In this case, a cookie for the subdomain “AAA.example.com” of authentication service is issued and thus an authentication token can be obtained from the cookie. The authentication server 102 confirms authorization by using the obtained authentication token. Processing in S403 to S405 and S501 is identical to the flowchart described in FIG. 5 and thus the explanation thereof is omitted.

In the present embodiment, the cookie has been already issued with a narrow domain scope where the subdomain “AAA.example.com” is set. Thus, the cookie is not reissued and only the cookie is issued with a wide domain scope where the domain “example.com” is set.

In S612, the terminal 105 redirects a received response to the resource server 104 as a response in S610.

When receiving the response of the authentication request, the resource server 104 acquires information from the cookie and provides service. Processing in S503 to S510 is identical to the flow described in FIG. 5 and thus the explanation thereof is omitted (Only one difference is that in S507 of FIG. 5, a cookie for the resource server 103 is issued, whereas in S507 of FIG. 6B, a cookie for the resource server 104 is issued).

According to the method of Embodiment 3, when a user accesses service without issuing a cookie, a cookie with a wide domain scope is optionally issued. In this case, if a cookie with a wide domain scope is used in accessed service, the cookie with a wide domain scope is disabled. This can prevent transfer of cookie information to unintended service while using the service of a plurality of subdomains. In the present embodiment, whether the user is authorized to use the service of the multiple subdomains is confirmed in S403. Whether the user is authorized to use requested service may be determined in S403.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-171711, filed Sep. 1, 2015, which is hereby incorporated by reference herein in its entirety.

### REFERENCE SIGNS LIST

102 authentication server
103 resource server
104 resource server
105 terminal
302 data management unit
320 web browser

1. An authentication server comprising:
a confirming unit configured to receive access to the authentication server from a terminal and confirm whether the terminal has an authorization to use a plurality of services provided by a plurality of subdomains in the same domain; and
an issuing unit configured to issue a cookie with a scope of use for the subdomains to the terminal if the confirming unit confirms that the terminal has the authorization, and issue a cookie with a scope of use for a subdomain of the authentication server to the terminal if the confirming unit confirms that the terminal does not have the authorization.

2. The authentication server according to claim 1, wherein the issuing unit is further configured to issue both of the cookie with the scope of use for the subdomains and the cookie with the scope of use for the subdomain of the authentication server.

3. The authentication server according to claim 2, wherein the authentication server is linked with a resource server, and
if the terminal accesses the resource server, the resource server obtains the cookie with the scope of use for the subdomains issued by the issuing unit, and issues a cookie with a scope of use for a subdomain of the resource server based on the obtained cookie.

4. The authentication server according to claim 3, wherein the resource server disables the obtained cookie after the issuance of the cookie with the scope of use for the subdomain of the resource server.

5. The authentication server according to claim 3, wherein if an effective cookie is unavailable when the terminal accesses the resource server, the resource server requests authentication to the authentication server, and the authentication server performs processing using the confirming unit and the issuing unit in response to the request.

6. An authentication method in an authentication server, comprising:
receiving access to the authentication server from a terminal and confirming whether the terminal has an authorization to use a plurality of services provided by a plurality of subdomains in the same domain; and
issuing a cookie with a scope of use for the subdomains to the terminal if it is confirmed in the confirming that the terminal has the authorization, and issuing a cookie with a scope of use for a subdomain of the authentication server to the terminal if it is confirmed in the confirming that the terminal does not have the authorization.

7. A non-transitory tangible medium having recorded thereon a program for implementing an authentication server by means of a computer,
the authentication server comprising:
a confirming unit configured to receive access to the authentication server from a terminal and confirm whether the terminal has an authorization to use a plurality of services provided by a plurality of subdomains in the same domain; and
an issuing unit configured to issue a cookie with a scope of use for the subdomains to the terminal if the confirming unit confirms that the terminal has the authorization, and issue a cookie with a scope of use for a subdomain of the authentication server to the terminal if the confirming unit confirms that the terminal does not have the authorization.
